(19) United States
(12) Patent Application Publication
(10) Pub. No.: US 2024/0289978 A1
(43) Pub. Date: Aug. 29, 2024

(54) MOVABLE OBJECT, MOVABLE OBJECT IMAGING SYSTEM, AND MOVABLE OBJECT IMAGING METHOD

(71) Applicant: FUJIFILM Corporation, Tokyo (JP)

(72) Inventors: Shuhei HORITA, Tokyo (JP); Kohei Sato, Tokyo (JP); Hiroaki Kikuchi, Tokyo (JP); Makoto Yonaha, Tokyo (JP)

(73) Assignee: FUJIFILM Corporation, Tokyo (JP)

(21) Appl. No.: 18/648,485

(22) Filed: Apr. 29, 2024

Related U.S. Application Data
(63) Continuation of application No. PCT/JP2022/037778, filed on Oct. 11, 2022.

(30) Foreign Application Priority Data
Nov. 19, 2021 (JP) 2021-188961

(51) Int. Cl. G06T 7/70

(52) U.S. Cl. CPC G06T 7/70

(57) ABSTRACT

Provided are a movable object including an imaging apparatus, a movable object imaging system, and a movable object imaging method capable of easily performing re-imaging. The movable object includes: a movable object body; an imaging apparatus that captures an image of an object; a processor that acquires imaging position information and imaging posture information of the imaging apparatus in a case where the image of the object is captured by the imaging apparatus; and a storage device that stores the imaging position information and the imaging posture information.

### CROSS-REFERENCE TO RELATED APPLICATIONS

The present application is a Continuation of PCT International Application No. PCT/JP2022/037778 filed on Oct. 11, 2022 claiming priority under 35 U.S.C § 119(a) to Japanese Patent Application No. 2021-188961 filed on Nov. 19, 2021. Each of the above applications is hereby expressly incorporated by reference, in its entirety, into the present application.

### BACKGROUND OF THE INVENTION

### 1. Field of the Invention

The present invention relates to a movable object, a movable object imaging system, and a movable object imaging method.

### 2. Description of the Related Art

In recent years, the utilization of imaging using a flying object such as a drone has become widespread (JP6803919B, JP2021-40220A, and JP6713156B). The utilization of imaging using a flying object is also studied for structure inspection.

### SUMMARY OF THE INVENTION

In imaging in the structure inspection, an imaging mistake that results in an imaging result inappropriate for the inspection of the structure may occur due to various field environments, ambient environments, environmental conditions during imaging, and the like. Thus, it is necessary to perform re-imaging.

The present invention has been made in view of such circumstances, and provides a movable object including an imaging apparatus, a movable object imaging system, and a movable object imaging method capable of easily performing re-imaging.

A movable object according to a first aspect comprises: a movable object body; an imaging apparatus that captures an image of an object; a processor that acquires imaging position information and imaging posture information of the imaging apparatus in a case where the image of the object is captured by the imaging apparatus; and a storage device that stores the imaging position information and the imaging posture information.

In the movable object according to a second aspect, the processor is configured to receive an imaging instruction based on the imaging position information and the imaging posture information.

In the movable object according to a third aspect, the imaging instruction includes a correction amount for at least one of the imaging position information or the imaging posture information.

In the movable object according to a fourth aspect, the imaging instruction includes an imaging parameter for the imaging apparatus.

In the movable object according to a fifth aspect, the processor is configured to generate an imaging route for the received imaging instruction.

In the movable object according to a sixth aspect, the processor is configured to control the imaging apparatus on the basis of the imaging instruction.

In the movable object according to a seventh aspect, the processor is configured to acquire the imaging position information from a positioning sensor provided in the movable object body, and the imaging posture information from an inertia measurement sensor provided in the movable object body.

In the movable object according to an eighth aspect, the movable object body is operated remotely or autonomously.

In the movable object according to a ninth aspect, the movable object body is an unmanned flying object or a mobile robot.

In the movable object according to a tenth aspect, the imaging apparatus acquires a two-dimensional color image.

In the movable object according to an eleventh aspect, the imaging apparatus acquires three-dimensional data.

A movable object imaging system according to a twelfth aspect comprises: a movable object that includes a movable object body and an imaging apparatus which captures an image of an object; and an information processing device that is capable of communicating with the movable object, in which the information processing device includes a processor and a storage device, the processor acquires imaging position information and imaging posture information of the imaging apparatus in a case where the image of the object is captured by the imaging apparatus, and the storage device stores the imaging position information and the imaging posture information.

A movable object imaging method according to a thirteenth aspect comprises: a step of imaging an object with an imaging apparatus provided in a movable object; a step of acquiring imaging position information and imaging posture information of the imaging apparatus in a case where an image of an object is captured by the imaging apparatus; and a step of storing the imaging position information and the imaging posture information.

The movable object imaging method according to a fourteenth aspect further comprises: a step of re-imaging the object on the basis of the imaging position information and the imaging posture information.

According to the movable object, the movable object imaging system, and the movable object imaging method comprising the imaging apparatus according to the aspect of the present invention, it is possible to easily perform re-imaging on an object.

### BRIEF DESCRIPTION OF THE DRAWINGS

FIG. 1 is a diagram conceptually showing a movable object imaging system.

FIG. 2 is a block diagram showing functions of a movable object.

FIG. 3 is a block diagram of a controller.

FIG. 4 is a block diagram of an information processing device.

FIG. 5 is a block diagram of a processing device control section.

FIG. 6 is a diagram showing imaging of an object through the movable object.

FIG. 7 is a flowchart showing an information processing method in the information processing device.

FIG. 8 is a diagram showing acquisition of an image group through the information processing device.

FIG. 9 is a diagram showing a failure image displayed on a display device of the information processing device.

FIG. 10 is a schematic diagram showing a relationship between a captured image and a depth of field.

FIG. 11 is a diagram showing an example of a re-imaging confirmation screen.

FIG. 12 is a diagram showing an example of processing of specifying an adjacent relationship of captured images.

FIG. 13 is a diagram showing another example of processing of specifying the adjacent relationship of the captured images.

FIG. 14 is a diagram showing processing of instructing the movable object to perform re-imaging.

FIG. 15 is a diagram showing the re-imaging by the imaging apparatus of the movable object.

FIGS. 16A to 16C are diagrams showing a generated imaging route.

### DESCRIPTION OF THE PREFERRED EMBODIMENTS

Hereinafter, preferred embodiments of a movable object according to the present invention will be described with reference to the accompanying drawings.

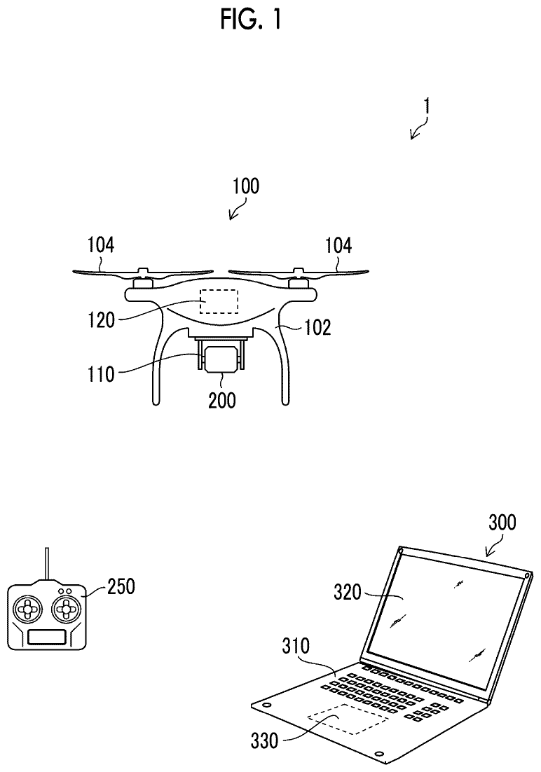

FIG. 1 is a diagram conceptually showing a movable object imaging system 1 composed of a movable object 100, a controller 250, and an information processing device 300. The movable object 100 has a movable object body 102, a propulsion section 104 provided in the movable object body 102, and a control device 120 provided in the movable object body 102. The movable object body 102 is a main constituent member of the movable object 100. The movable object body 102 is controlled by the control device 120. The movable object body 102 is, for example, an unmanned flying object, and a drone can be shown as an example thereof. The movable object body 102 includes a plurality of propellers and a propeller driving motor. The propeller and the propeller driving motor constitute the propulsion section 104.

Although an unmanned flying object is shown as the movable object body 102, the movable object body 102 may be a mobile robot, a vehicle, or a ship. The movable object body 102 can be configured by a remote operation or an autonomous type. The remote operation means that a user operates the movable object body 102 by giving an instruction to the control device 120 from the controller 250 from a position which is distant from the movable object body 102. The term “autonomous type” means that the control device 120 operates the movable object body 102 in accordance with a program or the like created in advance without the intervention of the user. The program or the like is appropriately changed depending on a place at which the movable object 100 is used.

An imaging apparatus 200 is mounted on the movable object 100. The imaging apparatus 200 is attached to the movable object body 102 with, for example, a gimbal 110 interposed therebetween. The imaging apparatus 200 is controlled by the control device 120 provided in the movable object body 102. While the movable object 100 flies in the atmosphere, the imaging apparatus 200 mounted on the movable object 100 captures an image of an object. The object is, for example, a civil engineering structure such as a bridge, a dam, or a tunnel, or a building structure such as a building, a house, a wall, a pillar, or a beam of a building. However, the object is not limited to a civil engineering structure and a building structure.

The information processing device 300 includes, for example, an operating section 310, a display device 320, and a processing device control section 330. The processing device control section 330 is composed of a computer which includes a central processing unit (CPU), a read-only memory (ROM), a random-access memory (RAM), a storage device, and the like.

### <Movable Object>

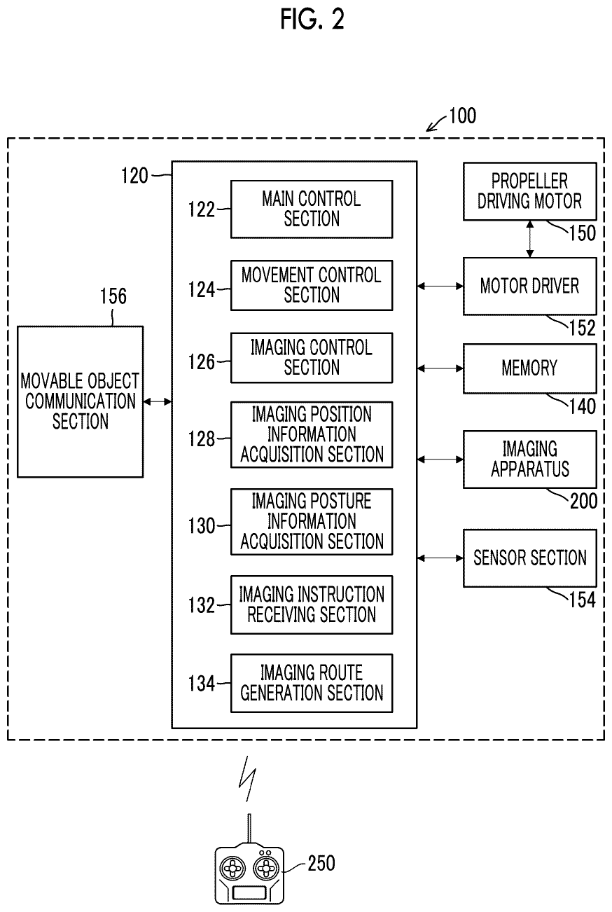

FIG. 2 is a block diagram showing a configuration of the movable object 100. The movable object 100 includes the control device 120, a memory 140, a propeller driving motor 150, a motor driver 152, a sensor section 154, a movable object communication section 156, and the imaging apparatus 200. The control device 120 is, for example, a CPU, and constitutes a processor.

The control device 120 includes a main control section 122, a movement control section 124, an imaging control section 126, an imaging position information acquisition section 128, an imaging posture information acquisition section 130, an imaging instruction receiving section 132, and an imaging route generation section 134. The main control section 122 controls all functions of the sections of the movable object 100. The main control section 122 performs signal processing, input and output of data, various kinds of arithmetic processing between the main control section 122 and the memory (storage device) 140, and processing of storing and acquiring data. The control device 120 executes a program to be able to function as the main control section 122, the movement control section 124, the imaging control section 126, the imaging position information acquisition section 128, the imaging posture information acquisition section 130, the imaging instruction receiving section 132, and the imaging route generation section 134.

The memory 140 stores information necessary for an operation of the movable object 100. The memory 140 stores an operation program, flight route information, imaging information, and the like. Further, the memory 140 is able to store information such as position information, posture information, and a captured image, which can be acquired in a case where the movable object 100 captures an image of the object while flying. The memory 140 may be, for example, a storage medium, such as a secure digital card (SD card) or a Universal Serial Bus memory (USB memory), which is attachable to and detachable from the movable object 100.

The movement control section 124 controls flight (movement) of the movable object 100 by controlling driving of the propeller driving motor 150 via the motor driver 152. The movement control section 124 controls the flight of the movable object 100 by controlling driving of each propeller driving motor 150, on the basis of a control signal transmitted from the controller 250 and information about a flight state of the movable object 100 which is output from the sensor section 154.

In a case where the flight route information is stored in the memory 140 in advance, the movement control section 124 acquires the information about the flight route (for example, the altitude, the speed, the range, or the like) from the memory 140, and is able to control the flight of the movable object 100 on the basis of the information about the flight route. As a result, autonomous flight can be performed.

The sensor section 154 detects the flight state of the movable object 100. The sensor section 154 includes a positioning sensor such as global navigation satellite system (GNSS), Global Positioning System (GPS), or real-time kinematic (RTK). The positioning sensor acquires position information of the movable object 100 such as latitude, longitude, and altitude. Further, the sensor section 154 includes a gyro sensor, a geomagnetic sensor, an acceleration sensor, a speed sensor, and an inertia measurement sensor configured by a combination of these sensors as a plurality of axes. The inertia measurement sensor acquires posture information of the movable object 100 such as information indicating an orientation of the movable object 100.

The movable object communication section 156 communicates with the controller 250 wirelessly under the control of the control device 120 to transmit and receive various signals and various pieces of information to and from each other. For example, in a case where the controller 250 is operated, a control signal based on the operation is transmitted from the controller 250 to the movable object 100. The movable object communication section 156 receives the control signal transmitted from the controller 250 and outputs the control signal to the control device 120. The movable object communication section 156 transmits signals and information from the control device 120 to the controller 250.

The imaging control section 126 causes the imaging apparatus 200 to perform imaging on the basis of imaging parameters. The imaging parameters include a shutter speed, an F number, an exposure correction amount, an ISO sensitivity, a focus position, a focal length, strobe light emission ON/OFF, a strobe light emission amount, light ON/OFF, and the like. The imaging apparatus 200 may automatically set the imaging parameters. In a case where the imaging apparatus 200 captures a plurality of images, the imaging parameters include an interval of the imaging positions and an overlap rate of the imaging ranges. Further, the overlap rate of the imaging ranges includes an overlap rate of the imaging ranges on the flight routes and a side lap rate of the imaging ranges between the flight routes. The overlap rate can be adjusted by, for example, a distance, a time, or the like of traveling of the movable object 100 in a traveling direction, and the side lap rate can be adjusted depending on the flight route. The imaging parameters are stored in, for example, the memory 140. Also, the imaging parameters can be transmitted from the controller 250 to the movable object 100. The transmitted imaging parameters are output to the control device 120 via the movable object communication section 156. The imaging control section 126 stores captured images captured by the imaging apparatus 200 in the memory 140. The captured images may include imaging parameters during imaging.

The imaging apparatus 200 is controlled by the imaging control section 126 to capture an image of the object. The imaging apparatus 200 acquires a two-dimensional color image as the captured image. The imaging apparatus, which acquires the two-dimensional color image, includes an imaging element such as a complementary metal-oxide-semiconductor (CMOS). The imaging element has a plurality of pixels composed of photoelectric conversion elements which are two-dimensionally arrayed in an x direction (horizontal direction) and a y direction (vertical direction). On upper surfaces of the plurality of pixels, for example, color filters, in which filters of R (red), G (green), and B (blue) are two-dimensionally arrayed in a Bayer array, are disposed. The two-dimensional color image is a so-called planar image which has no information in a depth direction.

The imaging apparatus 200 may acquire three-dimensional data in addition to the two-dimensional color image. The imaging apparatus, which acquires the three-dimensional data, is, for example, a stereo camera. The stereo camera simultaneously captures images of the object from a plurality of imaging apparatuses disposed at different positions to acquire the three-dimensional data in a range up to the object using parallax between the images. In a case where the imaging apparatus which acquires the three-dimensional data is a stereo camera, one of the plurality of imaging apparatuses can be used as the imaging apparatus which acquires the two-dimensional color image.

It should be noted that the description has been given of a case where the imaging apparatus which acquires the three-dimensional data is a stereo camera. The three-dimensional data can be acquired using an imaging apparatus such as a laser scanner or a time-of-flight (ToF) type camera.

The laser scanner emits laser pulses to the object and measures a distance depending on a time until the laser pulses reflected by a surface of the object are returned. The time-of-flight type camera acquires the three-dimensional data by measuring the flight time of light. Information about a distance between the imaging apparatus 200 and the object can be acquired by acquiring the three-dimensional data.

The imaging position information acquisition section 128 acquires position information of the movable object 100 in a case where the imaging apparatus 200 performs imaging, as imaging position information, for example, from the positioning sensor of the sensor section 154. The imaging position information acquisition section 128 stores the acquired imaging position information in the memory 140 in association with the captured images.

The imaging posture information acquisition section 130 acquires posture information of the imaging apparatus 200 in a case where the imaging apparatus 200 performs imaging. For example, in a case where the orientation of the imaging apparatus 200 can be adjusted by the gimbal 110, the imaging posture information acquisition section 130 acquires gimbal control information (rotation angle or the like) and the posture information of the movable object 100 from the inertia measurement sensor of the sensor section 154, and combines the gimbal control information and the posture information of the movable object 100 to acquire a combination thereof as the imaging posture information. In contrast, in a case where the orientation of the imaging apparatus 200 is fixed, the posture information of the movable object 100, which is acquired from the inertia measurement sensor of the sensor section 154, is acquired as the imaging posture information of the imaging apparatus 200. The imaging posture information acquisition section 130 stores the acquired imaging posture information in the memory 140 in association with the captured images.

The flight route of the movable object 100 and an imaging condition of the imaging apparatus 200 can be determined in advance using control software or the like.

The imaging instruction receiving section 132 receives an imaging instruction based on the imaging position information and the imaging posture information stored in the movable object 100 by which the image of the object has been captured. Here, in a case where the captured image captured by the imaging apparatus 200 is a failure image which does not satisfy a predetermined criterion, the imaging instruction receiving section 132 receives an instruction to perform re-imaging on an imaging failure portion where the failure image was captured. The imaging instruction receiving section 132 receives an instruction to perform re-imaging on a premise that the imaging position information and the imaging posture information, which are obtained in a case where a failure image is captured, are used. In a case where the imaging instruction receiving section 132 receives the instruction to perform re-imaging, the movable object 100 moves to the imaging position on the basis of the stored imaging position information and the imaging posture information, and the imaging apparatus 200 performs re-imaging on the imaging failure portion in an imaging posture. By making it possible to receive the re-imaging instruction in the stored imaging position and imaging posture, the imaging work, which includes the re-imaging of the imaging failure portion, can be efficiently performed, and the work time can be shortened.

Further, it is preferable that the imaging instruction includes identification information that is for specifying a captured image for which the re-imaging is necessary, such as an imaging order, a photograph number, and a file name obtained in a case where the captured image is stored, which are associated with the captured image acquired before the re-imaging. The identification information enables easy acquisition of the imaging position information and the imaging posture information.

The imaging instruction may include a correction amount for at least one of the imaging position information or the imaging posture information. By adding the correction amount to the imaging instruction, it is possible to reduce a probability that re-imaging of the failure image is performed. Here, the re-imaging may be performed on the basis of the imaging position information and the imaging posture information in the same manner as the failure image.

It is preferable that the imaging instruction includes imaging parameters. The imaging parameters include a shutter speed, an F number, an exposure correction amount, an ISO sensitivity, a focus position, a focal length, strobe light emission ON/OFF, a strobe light emission amount, light ON/OFF, and the like. The imaging parameters in a case where the re-imaging is performed may be the same as those of the failure image which was captured before the re-imaging, or may include the correction amount.

The imaging route generation section 134 generates an imaging route for the imaging failure portion for which the imaging instruction for re-imaging is received. The imaging route generation section 134 may generate, for example, an imaging route such that a total moving distance of imaging of all portions for which the imaging instructions are received is shortest. Further, the imaging route generation section 134 may generate, for example, an imaging route that goes around in a predetermined order and that has the shortest moving distance. The predetermined order is an order (for example, an ascending order) of photograph numbers of the imaging failure portions for which the imaging instructions are received.

### <Controller>

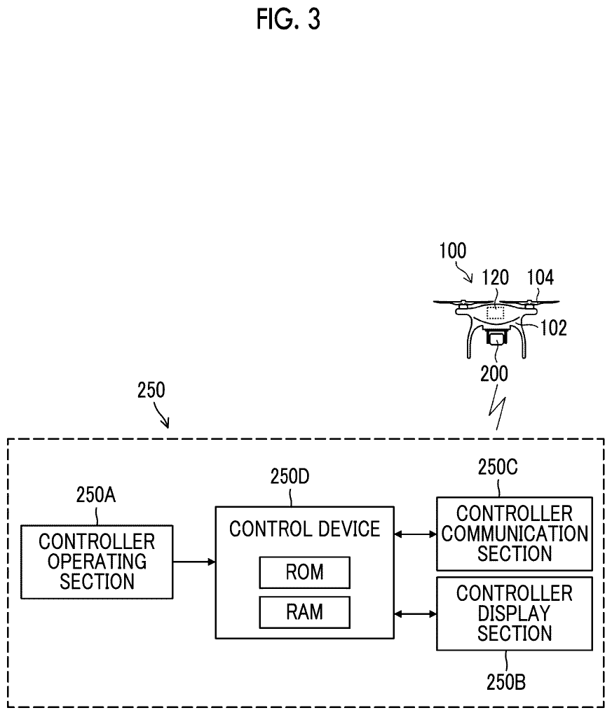

FIG. 3 is a block diagram showing a configuration of a controller.

The controller 250 includes a controller operating section 250A, a controller display section 250B, a controller communication section 250C, and a control device 250D.

The controller operating section 250A is configured to include various operating members that operate the movable object 100. The operating members that operate the movable object body 102, which includes the propulsion section, include, for example, an operating member that instructs the movable object body 102 to move up or down, an operating member that instructs the movable object body 102 to turn, and the like. The operating members that operate the imaging apparatus 200 include, for example, an operating member that issues an instruction to start imaging or to end imaging, and the like.

The controller display section 250B is configured to include, for example, a liquid-crystal display (LCD). For example, information about the flight state of the movable object 100 is displayed on the controller display section 250B.

The controller communication section 250C communicates with the movable object 100 wirelessly to transmit and receive various signals to and from each other under the control of the control device 250D.

The control device 250D is a control section that integrally controls the overall operation of the controller 250. The control device 250D is a CPU, and includes a ROM and a RAM. The control device 250D executes a predetermined program to implement various functions. For example, in a case where the controller operating section 250A is operated, a control signal corresponding to the operation is generated. The control signal is transmitted to the movable object 100 via the controller communication section 250C. Further, the controller 250 acquires information about a flight state from the movable object 100 via the controller communication section 250C, and displays information about the controller display section 250B. The program is stored in the ROM.

Further, the controller 250 can transmit the imaging instruction for re-imaging to the movable object 100.

### <Information Processing Device>

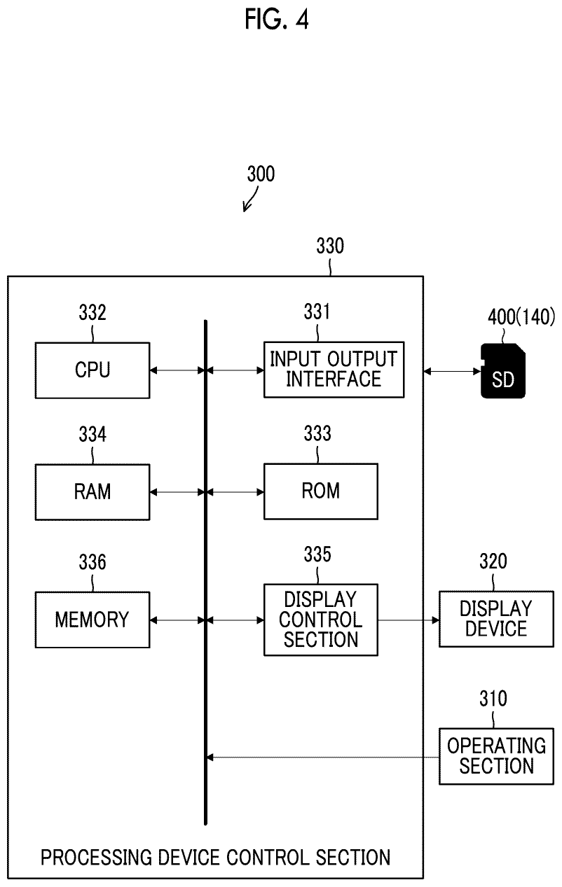

FIG. 4 is a block diagram of the information processing device.

As described above, the information processing device 300 includes the operating section 310, the display device 320, and the processing device control section 330. The processing device control section 330 mainly includes an input output interface 331, a CPU 332, a ROM 333, a RAM 334, a display control section 335, and a memory 336.

The display device 320 constituting a display is connected to the information processing device 300, and performs display on the display device 320 through control of the display control section 335 under a command of the CPU 332. The display device 320 is, for example, a device such as a liquid-crystal display and is able to display various types of information.

The operating section 310 includes a keyboard and a mouse, and a user is able to cause the processing device control section 330 to perform necessary processing via the operating section 310. In a case where a touch panel type device is used, the display device 320 is able to also function as the operating section 310. It should be noted that although examples have described a system in which the controller 250 and the information processing device 300 are separated, the controller 250 and the information processing device 300 may be integrated. The controller 250 is a device from which the communication function of the information processing device 300 is separated, and the transmission and reception to the movable object 100 through the controller 250 constitute a part of the function of the processing device control section 330 of the information processing device 300.

The input output interface 331 is able to input and output various kinds of information to and from the information processing device 300. For example, the information stored in the memory 336 is input and output via the input output interface 331. The input output interface 331 is able to input and output the information to and from a storage medium 400 that is present outside the processing device control section 330. Examples of the storage medium 400 may include an SD card, a USB memory, and the like. Further, information can be input and output not only to the storage medium 400 but also to a network connected to the information processing device 300. The storage medium 400 is, for example, the memory 140 of the movable object 100.

The memory 336 is a memory composed of a hard disk apparatus, a flash memory, or the like. The memory 336 stores data and a program, which are for operating the information processing device 300, such as an operating system and a program that causes the information processing device 300 to perform processing.

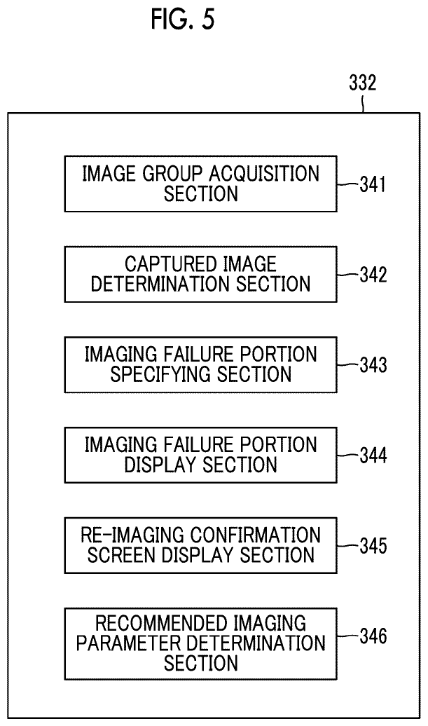

FIG. 5 is a block diagram showing processing functions implemented by the CPU 332.

The CPU 332 includes an image group acquisition section 341, a captured image determination section 342, an imaging failure portion specifying section 343, an imaging failure portion display section 344, a re-imaging confirmation screen display section 345, and a recommended imaging parameter determination section 346. The image group acquisition section 341, the captured image determination section 342, the imaging failure portion specifying section 343, the imaging failure portion display section 344, the re-imaging confirmation screen display section 345, and the recommended imaging parameter determination section 346 each are a part of the CPU 332. The CPU 332 executes the processing of each section.

It should be noted that each section of the CPU 332 executes the following processing. The image group acquisition section 341 acquires an image group which includes a plurality of captured images of the object captured by the movable object 100. The captured image determination section 342 determines whether each captured image of the plurality of captured images satisfies a predetermined criterion for the acquired image group. The imaging failure portion specifying section 343 specifies an imaging failure portion of a failure image for which it is determined that the criterion is not satisfied. The imaging failure portion display section 344 displays an adjacent relationship of the image group and the imaging failure portion on the display device 320. The re-imaging confirmation screen display section 345 displays a confirmation screen as to whether to perform re-imaging of the failure image on the display device, and receives an instruction as to whether or not to perform the re-imaging. The recommended imaging parameter determination section 346 determines a recommended imaging parameter for the imaging failure portion on the basis of the contents of the failure image.

Next, the movable object imaging system 1 will be described.

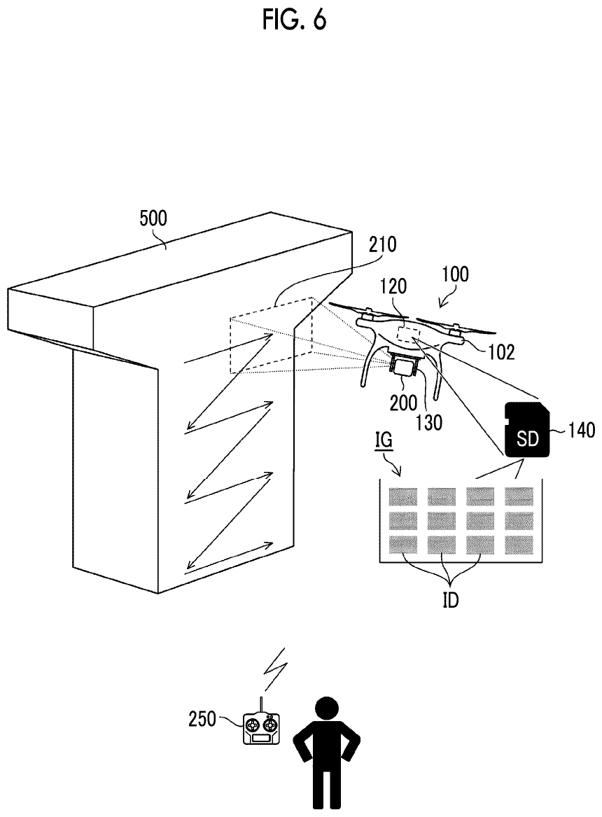

In the movable object imaging system 1, first, as shown in FIG. 6, the imaging apparatus 200 of the movable object 100 captures an image of an object 500. The object 500 is, for example, a bridge pier. Further, the movable object 100 is an unmanned aerial vehicle (UAV).

The movable object 100 flies around the object 500 on the basis of the control signal transmitted from the controller 250. Further, the imaging apparatus 200 mounted on the movable object 100 captures an image of an outer wall of the object 500 while moving the imaging range with respect to the object 500 in accordance with the movement of the movable object 100 on the basis of the control signal from the control device 120. The imaging apparatus 200 acquires a captured image in an angle-of-view range 210 each time imaging is performed. Furthermore, the imaging apparatus 200 captures images of the object 500 in a dividing manner to acquire a plurality of captured images. A plurality of captured images ID acquired by one flight of the movable object 100 are acquired as one image group IG, and the acquired image group is stored in the memory 140 of the movable object 100.

Each time imaging is performed, the control device 120 acquires the imaging position information and the imaging posture information from the sensor section 154 or from the control signals of the sensor section 154 and the gimbal 110, and stores the imaging position information and the imaging posture information in the memory 140 in association with the captured images. Regarding the association with the captured image, identification information, such as a file name, a file ID, and a photograph number assigned to any position, which can specify the captured image can be associated with the imaging position information and the imaging posture information. The information is stored in, for example, a format of a table in the memory 140.

The imaging apparatus 200 essentially acquires a two-dimensional color image as the captured image. It should be noted that the imaging apparatus 200 may simultaneously acquire the three-dimensional data.

In order to acquire the imaging position information and the imaging posture information, simultaneous localization and mapping (SLAM) or structure from motion (SfM) can be applied. The SLAM is able to estimate positions of the feature points and the imaging position information and the imaging posture information of the imaging apparatus 200 simultaneously by using a set of feature points updated dynamically depending on a change in the input image from the imaging apparatus 200.

The SfM tracks a plurality of feature points on the captured image which is captured while the imaging apparatus 200 is moved, and calculates the imaging position information and the imaging posture information of the imaging apparatus 200 and three-dimensional positions of the feature points by using an association relationship of the feature points.

In a case of using the SLAM or the SfM, the control device 120 of the movable object 100 calculates the imaging position information and the imaging posture information. Thus, the calculated imaging position information and the calculated imaging posture information can be stored in the memory 140.

Further, in a case of using the SLAM or the SfM, the processing device control section 330 of the information processing device 300 calculates the imaging position information and the imaging posture information. Thus, the calculated imaging position information and the calculated imaging posture information can be stored in the memory 336.

Further, each time imaging is performed, the control device 120 may acquire the imaging position information and the imaging posture information from the sensor section 154 or from the control signals of the sensor section 154 and the gimbal 110, and may transmit the imaging position information and the imaging posture information to the information processing device 300. Thus, the imaging position information and the imaging posture information may be stored in the memory 336 of the information processing device 300.

Further, in a case of using the SLAM or the SfM, the control device 120 of the movable object 100 may calculate the imaging position information and the imaging posture information, and may transmit the imaging position information and the imaging posture information to the information processing device 300. The imaging position information and the imaging posture information may be stored in the memory 336 of the information processing device 300.

Therefore, in the movable object imaging system 1, in a case where the imaging apparatus 200 of the movable object 100 captures the image of the object 500, as long as the imaging position information and the imaging posture information of the imaging apparatus 200 during imaging of the object 500 may be acquired and may be stored, it is sufficient if the processing may be executed by any of the control device 120 of the movable object 100 or the processing device control section 330 of the information processing device 300.

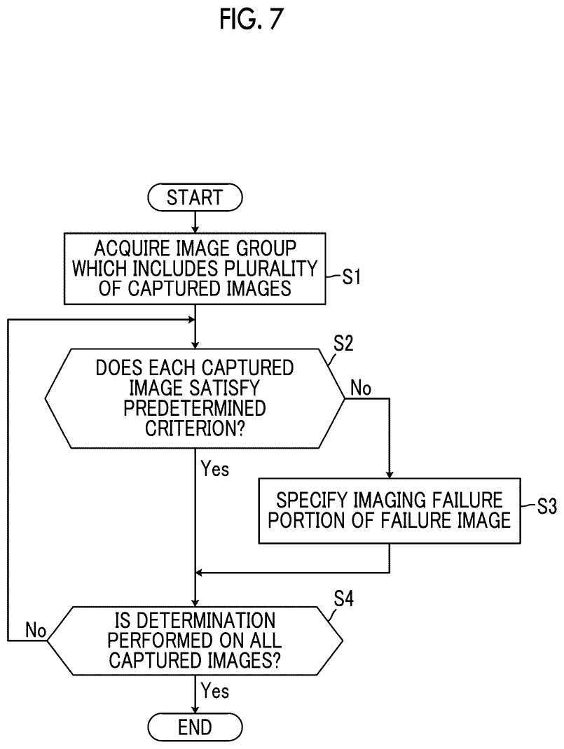

Next, an information processing method using the information processing device 300 will be described. FIG. 7 is a flowchart showing the information processing method using the information processing device 300. The information processing method includes a step of acquiring an image group which includes the plurality of captured images (Step S1), a step of determining whether each captured image satisfies the predetermined criterion (Step S2), a step of specifying the imaging failure portion of the failure image for which it is determined that the criterion is not satisfied (Step S3), and a step of confirming whether the determination is performed on all the captured images (Step S4).

As shown in FIG. 7, in Step S1, the image group acquisition section 341 of the CPU 332 acquires the image group IG which includes the plurality of captured images ID. In Step S2, the captured image determination section 342 of the CPU 332 determines whether each captured image ID satisfies the predetermined criterion. In Step S2, in a case where the result is Yes, that is, in a case where the captured image ID is not the failure image, the CPU 332 proceeds to Step S4. In Step S2, in a case where the result is No, that is, in a case where the captured image ID is the failure image, the CPU 332 proceeds to Step S3. In Step S3, the imaging failure portion specifying section 343 of the CPU 332 specifies the imaging failure portion of the failure image. In a case where the imaging failure portion of the failure image is specified, the CPU 332 proceeds to Step S4.

In Step S4, the CPU 332 confirms whether the determination is performed on all the captured images ID. In Step S4, in a case where the result is Yes, the processing ends. In a case where the result is No, the CPU 332 returns to Step S2 and repeats Step S2 to Step S4 until the determination is performed on all the captured images ID.

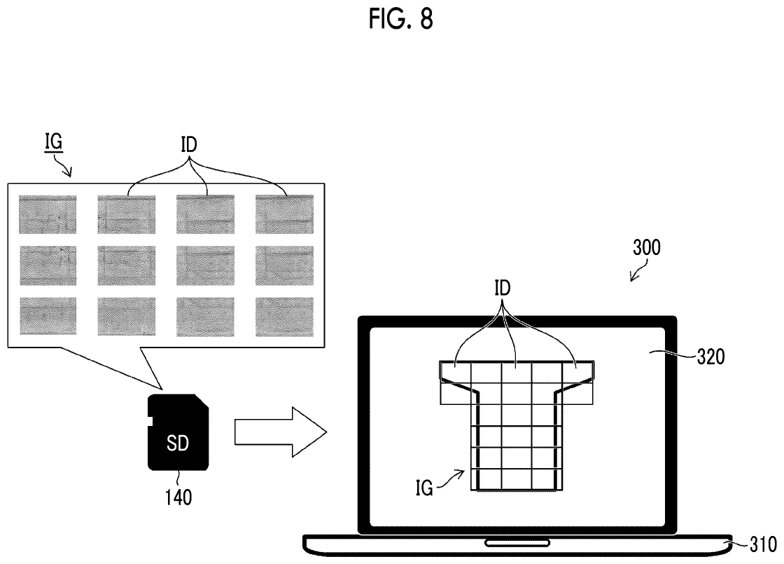

As shown in FIG. 8, the information processing device 300 acquires the image group IG which includes the plurality of captured images ID (Step S1). In FIG. 8, the processing device control section 330 of the information processing device 300 causes the information processing device 300 to acquire the plurality of captured images ID, which are stored in the memory 140, as the image group IG. For example, the memory 336 stores the acquired image group IG.

The method of acquiring the image group IG which includes the plurality of captured images ID from the memory 140 of the movable object 100 is not particularly limited. In a case where the memory 140 is attachable to and detachable from the movable object 100, the memory 140 may be mounted on the information processing device 300, and the information processing device 300 may acquire the image group IG from the memory 140. Further, the information processing device 300 may acquire the image group IG from the memory 140 of the movable object 100 by using the communication function of the controller 250. The information processing device 300 causes the display device 320 to display the image group IG which includes the plurality of acquired captured images ID.

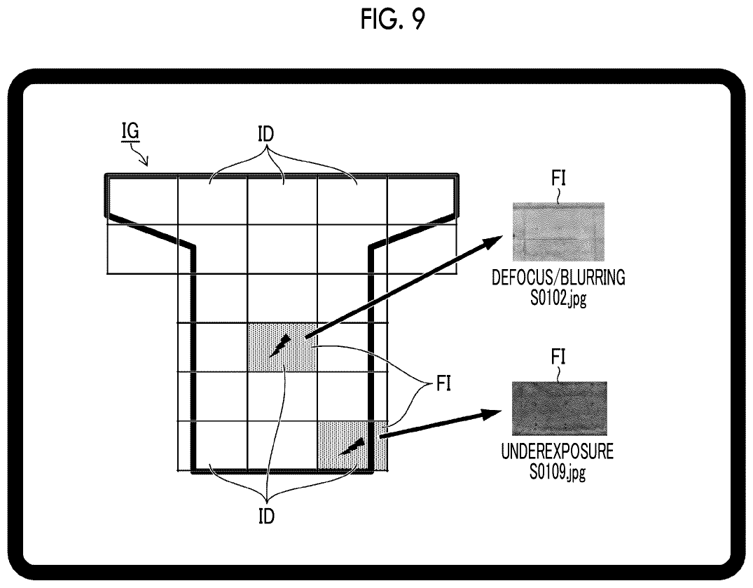

Next, the information processing device 300 determines whether each captured image ID satisfies the predetermined criterion (Step S2), specifies the imaging failure portion of the failure image for which it is determined that the criterion is not satisfied (Step S3), and confirms whether the determination is performed on all the captured images (Step S4). In a case where the confirmation is completed, as shown in FIG. 9, processing is executed on the imaging failure portion display section 344 of the CPU 332, and a failure image FI and the position of the imaging failure portion are displayed on the display device 320. The imaging failure portion display section 344 displays the adjacent relationship of the image group IG (the plurality of captured images ID) and the imaging failure portion on the display device 320.

Further, the imaging failure portion display section 344 causes the display device 320 to display the contents of the failure image FI specified by the imaging failure portion specifying section 343 in Step S3. In FIG. 9, two failure images FI and the imaging failure portions are displayed on the display device 320. Each failure image FI is displayed in an enlarged manner, and the content of failure is displayed. For example, “defocus/blurring” is displayed in the failure image FI which is positioned on an upper side. Furthermore, “underexposure” is displayed on the failure image FI which is positioned on a lower side. A user of the information processing device 300 is able to easily find the cause of the failure image FI. Moreover, since the failure image FI is enlarged and displayed, the user is able to visually confirm the failure image FI. The imaging failure portion display section 344 is able to display a reduced image of the failure image FI. By performing the display in a reduced manner, it is possible to increase the number of failure images FI displayed on the display device 320.

The imaging failure portion display section 344 displays the file name as the identification information of the failure image FI on the display device 320. “S0102.jpg” is displayed on the failure image FI which is positioned on the upper side, and “S0109.jpg” is displayed on the failure image FI which is positioned on the lower side.

Next, the processing of the captured image determination section 342 in Step S2 will be described. The captured image determination section 342 is able to determine whether or not the captured image ID satisfies the criterion through the following method. The first method is a method of determining the captured image ID on the basis of image analysis.

The captured image determination section 342 performs image analysis of the captured image ID to determine whether the captured image ID is “defocus”, “blurring”, “overexposure”, “underexposure”, or “no problem”. For example, the memory 336 stores the captured image ID, in association with the content determined for each captured image ID.

First, a method for determining “defocus” or “blurring” will be described. The method of determining whether the captured image ID is “defocus” or “blurring” includes a case of performing the determination on the basis of the captured image ID and a case of performing the determination on the basis of a state during imaging. There are two types of methods for the determination based on the captured image ID.

A learning model using machine learning can be used as an example in which the determination is performed on the basis of the captured image ID. For example, an image group with or without defocus and an image group with or without blurring are provided, and the learning model for image determination is created in a machine learning device using the image groups as training data. The captured image determination section 342 using the created learning model is able to determine whether defocus is present or absent or whether blurring of the captured image ID is present or absent.

Further, in the captured image determination, it is preferable that the captured image determination section 342 discriminates that the object 500 is concrete, steel, or the like. In the discrimination of the object 500, the image group of concrete, steel, or another material is provided, and the learning model for object determination is created by a machine learning device using the image groups as training data.

The captured image determination section 342 is able to determine whether or not a desired object region overlaps with a defocus region or a blurring region by using the learning model for the object determination and the learning model for the image determination. The learning model using machine learning is a predetermined criterion.

As another example in which the determination is performed on the basis of the captured image ID, determination using an image analysis algorithm can be used. As the image analysis algorithm, spatial frequency analysis may be used to determine defocus or blurring. The captured image determination section 342 performs spatial frequency analysis on the captured image ID to determine whether high-frequency components are present or absent. In a case where defocus or blurring is present in the captured image ID, the high-frequency components are lost. In a case where the high-frequency components are present, it can be determined that there is no defocus or blurring. In a case where there are no high-frequency components, it can be determined that there is defocus or blurring. It should be noted that presence or absence of the high-frequency components can be determined by a threshold value, and the threshold value can be optionally determined in advance.

In the image analysis algorithm, the threshold value is a predetermined criterion.

Further, blurring or defocus can be determined on the basis of the state during imaging. For example, the captured image determination section 342 is able to determine the “blurring” from an association relationship between a shutter speed of the captured image ID and a movement speed of the movable object 100. For example, movement speed (m/sec)×shutter speed (sec)=moving distance (m) while the shutter is open. As compared with a size of one pixel of the imaging element, in a case where the moving distance (m) is within the size of one pixel of the imaging element, it can be determined that “there is no blurring”. In a case where the size is greater than the size of one pixel of the imaging element, it can be determined that “there is blurring”. Information about the shutter speed can be acquired from the imaging apparatus 200 or an exchangeable image file format (Exif). Furthermore, the movement speed of the movable object 100 can be acquired from the sensor section 154.

Whether the moving distance (m) is within the size of one pixel of the imaging element is set as a predetermined criterion.

Further, the captured image determination section 342 is able to determine the defocus on the basis of the information as to whether the image was captured after the subject was in focus. The captured image determination section 342 is able to perform the determination from an association relationship between the focus position and the object region of the captured image ID. As the information as to whether the imaging was performed after the subject was in focus, the information can be acquired from the imaging apparatus 200 or the Exif. The object region can be discriminated by using a learning model of the object determination. In such a case, the captured image ID in which the focus position is in “the other” region can be determined as a “defocus” image, and is a predetermined criterion.

Next, a determination method of “underexposure” or “overexposure” will be described. In the method of determining whether the captured image ID is “underexposure” or “overexposure”, the determination is performed on the basis of the captured image ID. Here, two methods will be described as the determination method based on the captured image ID.

It should be noted that the “underexposure” refers to a state where the captured image ID is excessively dark or to a state where the underexposure is present, and the “overexposure” means that the captured image ID is excessively bright. The “overexposure” indicates a state where overexposure is present.

A learning model using machine learning can be used as an example in which the determination is performed on the basis of the captured image ID. For example, image groups of underexposure, overexposure, and appropriate exposure are provided, and a learning model of image determination is created by the machine learning device using the image groups as the training data. The captured image determination section 342 using the created learning model is able to determine the underexposure or the overexposure of the captured image ID. The learning model using machine learning is a predetermined criterion.

As another example in which the determination is performed on the basis of the captured image ID, determination using an image analysis algorithm can be used. As the image analysis algorithm, the determination may be performed on the basis of a histogram of pixel values (RGB values) constituting the captured image ID. The captured image determination section 342 creates the histogram of the RGB values, determines that the captured image ID, in which pixels having RGB values equal to or less than a certain threshold value (for example, 10 or less) are present at a predetermined ratio, is underexposed, and determines that the captured image ID, in which pixels having RGB values equal to or greater than a certain threshold value (for example, 245 or more) are present at the predetermined ratio, is overexposed. The threshold value and the ratio can be optionally determined in advance, and these are the predetermined criteria.

Next, a description will be given of a case where the captured image ID is determined on the basis of an imaging resolution and a case where the captured image ID is determined on the basis of an imaging angle. The determination based on the imaging resolution includes a case of performing determination on the basis of the captured image ID and a case of performing determination on the basis of a state at the time of imaging. Further, the case of determining the captured image ID on the basis of the imaging angle includes a case of determination based on the captured image ID and a case of determination based on the state at the time of imaging.

First, in the determination of the imaging resolution (mm/pixel), the captured image ID is determined on the basis of whether a desired imaging resolution is satisfied.

As the determination criteria, for example, a resolution of 0.3 mm/pixel or more (0.3 mm/pixel, 0.2 mm/pixel, . . . , or the like) is necessary in order to detect fissuring with a width of about 0.1 mm or more, and a resolution of 0.6 mm/pixel or more (0.6 mm/pixel, 0.5 mm/pixel, . . . , or the like) is necessary in order to detect fissuring with a width of about 0.2 mm or more. As for the threshold value of the imaging resolution (mm/pixel), the determination threshold value may be automatically set in accordance with the desired inspection conditions, or may be adjustable by a user. The threshold value is the predetermined criterion.

In a case where the imaging resolution is determined on the basis of the captured image ID, the captured image determination section 342 is able to estimate the imaging resolution through image recognition of a structure (concrete: P cone mark, formwork mark, steel: rivet, bolt, or the like) having a known size to determine whether the captured image ID satisfies the criterion. It should be noted that the P cone mark is a hole of a P cone (plastic cone) removed from a separate bolt which is present on a surface of a concrete wall.

In a case where the imaging resolution is determined on the basis of the state at the time of imaging, the captured image determination section 342 estimates the imaging resolution on the basis of information from the sensor section 154 and the imaging apparatus 200 of the movable object 100 to determine whether the captured image ID satisfies the criterion.

For example, in a case where a lens of the imaging apparatus 200 of the movable object 100 is a single focus lens, the captured image determination section 342 estimates the imaging resolution from imaging distance information. The imaging distance information is acquired on the basis of the three-dimensional data which is acquired by the imaging apparatus 200 and/or the position information which is acquired by the positioning sensor of the sensor section 154.

In a case where the lens of the imaging apparatus 200 of the movable object 100 is a zoom lens, the captured image determination section 342 estimates the imaging resolution from the imaging distance information and focal length information. As in the case of the single focus lens, the imaging distance information is acquired on the basis of the three-dimensional data which is acquired by the imaging apparatus 200 and/or the position information which is acquired by the positioning sensor of the sensor section 154. The focal length information is acquired from the imaging apparatus 200 or the Exif.

Next, in a case where the captured image ID is determined on the basis of the imaging angle, regarding a depth of field determined in accordance with a subject distance, the focal length, the F number, and a permissible circle-of-confusion diameter, the captured image ID is determined depending on whether the captured image ID is within a range of the depth of field.

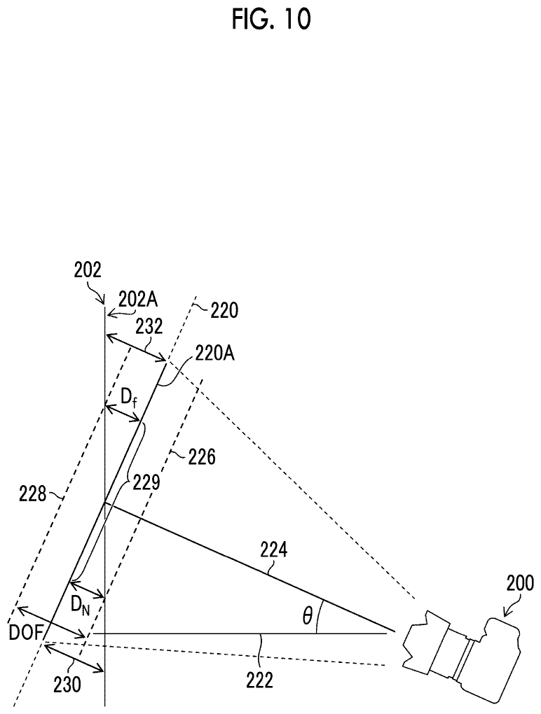

A relationship between the depth of field and the captured image ID will be described with reference to FIG. 10. A reference numeral D_{N} shown in FIG. 10 represents a front side depth of field. A reference numeral D_{f} represents a rear side depth of field. The front side depth of field D_{N} is represented by Expression 1. The rear side depth of field D_{f} is represented by Expression 2. The depth of field is represented by Expression 3.

$$Front side depth of field = \frac{\begin{matrix}Permissible circle ‐ of ‐ confusion diameter \times \\ F number \times Subject {distance}^{2}\end{matrix}}{\begin{matrix}Focal {length}^{2} + Permissible circle ‐ of ‐ \\ confusion diameter \times F number \times Subject distance\end{matrix}} \qquad [ Numerical Expression 1 ]$$

$$Rear side depth of field = \frac{\begin{matrix}Permissible circle ‐ of ‐ confusion diameter \times \\ F number \times Subject {distance}^{2}\end{matrix}}{\begin{matrix}Focal {length}^{2} - Permissible circle ‐ of ‐ confusion diameter \times \\ F number \times Subject distance\end{matrix}} \qquad [ Numerical Expression 2 ]$$

$$Depth of field = Front side depth of field + Rear side depth of field \qquad [ Numerical Expression 3 ]$$

In a case where the units of the front side depth of field D_{N} in Expression 1, the rear side depth of field D_{f} in Expression 2, and a depth of field DOF in Expression 3 are (mm), the units of the permissible circle-of-confusion diameter, the subject distances, and the focal lengths in Expressions 1 and 2 are (mm).

The permissible circle-of-confusion diameter means a diameter of the permissible circle of confusion. The permissible circle-of-confusion diameter is a pixel size of the imaging element which is provided in the imaging apparatus 200.

A reference numeral 220 of FIG. 10 represents an in-focus plane of the imaging apparatus 200. A solid line, which is designated by a reference numeral 220A, indicates an imaging range of the imaging apparatus 200. A region 229 represents a range within a depth of field. The imaging range in the vertical direction is calculated by dividing a value, which is obtained by multiplying the subject distance by a sensor size in the vertical direction, by the focal length. A unit which represents a length is used for the imaging range in the vertical direction.

The vertical direction is a direction to which a broken line representing the in-focus plane 220 shown in FIG. 10 is directed. The sensor size in the vertical direction is the size of the imaging element, which is provided in the imaging apparatus 200, in the vertical direction.

Further, the imaging range in the horizontal direction is calculated by dividing a value, which is obtained by multiplying the subject distance by the sensor size in the horizontal direction, by the focal length. A unit which represents a length is used for the imaging range in the horizontal direction.

The horizontal direction is a direction orthogonal to the vertical direction and represents a direction which penetrates a page plane of FIG. 10. The sensor size in the horizontal direction is the size of the imaging element, which is provided in the imaging apparatus 200 shown in FIG. 10, in the horizontal direction. An imaging angle θ is an angle formed between a subject surface vertical direction 222, which is a direction of a normal line of a subject surface 202A of a subject 202, and a direction 224 of an optical axis of the imaging apparatus 200.

A reference numeral 226 shown in FIG. 10 represents a front end of the depth of field. A reference numeral 228 represents a rear end of the depth of field. A reference numeral 230 represents an amount of shift in focal point on a front side of the in-focus plane 220. A reference numeral 232 represents an amount of shift in focal point on a rear side of the in-focus plane 220. The amount of shift in focal point can be calculated using geometric calculation as a distance from the subject surface 202A to the in-focus plane 220.

A ratio of the region 229 to the imaging range 220A of the imaging apparatus 200 is determined by the imaging angle θ in accordance with the degree of defocus. The captured image determination section 342 determines the captured image ID on the basis of whether the imaging angle θ is within a threshold value. The imaging angle θ may be automatically set or may be adjusted by a user.

In a case where the imaging angle is determined on the basis of the captured image ID, the captured image determination section 342 calculates the imaging angle θ by using a learning model that estimates a depth, and determines the captured image ID on the basis of the imaging angle θ.

In another example in which the imaging angle is determined on the basis of the captured image ID, the captured image determination section 342 extracts feature points of a plurality of captured images ID through SfM, performs estimation on the imaging apparatus 200 to estimate the imaging angle θ from an inclination of an object surface with respect to an imaging direction, and determines the captured image ID on the basis of the imaging angle θ.

In a case where the imaging angle is determined on the basis of the state during imaging, the captured image determination section 342 estimates the imaging angle θ from the imaging posture information of the movable object 100 and the control information (the rotation angle or the like) of the gimbal 110, and determines the captured image ID on the basis of the imaging angle θ. The imaging posture information can be acquired from a gyro sensor of the sensor section 154, and the control information of the gimbal 110 can be acquired from the imaging control section 126.

As shown in FIG. 9, in a case where the information processing device 300 displays the adjacent relationship of the plurality of captured images ID and the imaging failure portion on the display device 320, the re-imaging confirmation screen display section 345 of the CPU 332 displays a confirmation screen, which is for determining whether to perform re-imaging on the failure image FI, on the display device 320, and receives an instruction as to whether or not to perform the re-imaging.

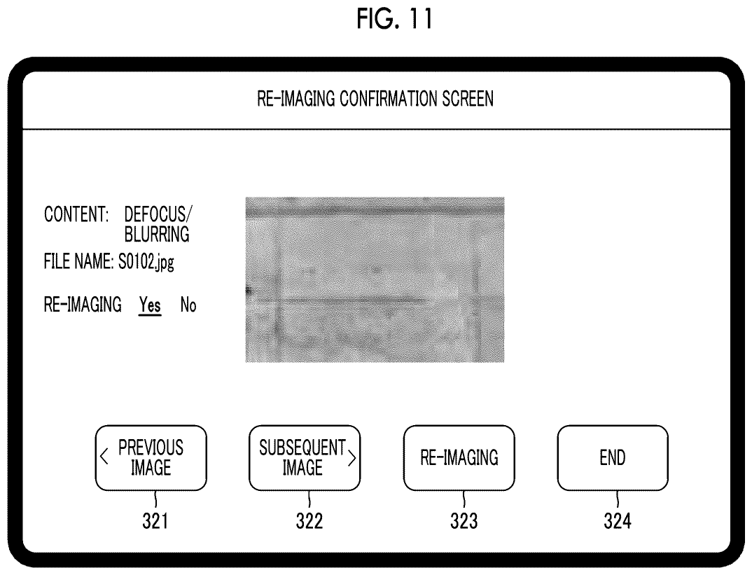

FIG. 11 is a diagram showing an example of a re-imaging confirmation screen. The re-imaging confirmation screen includes a previous image button 321, a subsequent image button 322, a re-imaging button 323, and an end button 324. The failure image FI and the contents and file name of the failure image FI are displayed on the re-imaging confirmation screen. In FIG. 11, one failure image FI is displayed on the re-imaging confirmation screen.

The previous image button 321 displays a failure image FI previous to the failure image FI being displayed. The subsequent image button 322 displays a failure image FI subsequent to the failure image FI being displayed. By sorting the failure images FI in the order of file names, in the imaging order, or the like and operating the previous image button 321 and the subsequent image button 322, a user is able to check the failure images FI in the order of file names, in the imaging order, or the like.

With the re-imaging button 323, the CPU 332 receives an instruction as to whether or not to perform re-imaging. The re-imaging button 323 is operated to execute reception of the re-imaging of the failure images FI. In a case where the re-imaging is determined, “Yes” in the re-imaging field is highlighted and underlined. A user is able to visually confirm that performing the re-imaging on the failure images FI has been determined.

It should be noted that in a case where the re-imaging button 323 is operated again in a state of “Yes” in the re-imaging field, the determination of the re-imaging is canceled, and “No” in the re-imaging field is highlighted and underlined. A user is able to visually confirm that the re-imaging will not be performed on the failure images FI. The re-imaging field may be in the form of a checkbox.

The end button 324 ends the re-imaging confirmation screen. In a case where a user operates the end button 324, the instruction as to whether or not to perform the re-imaging is determined, and the CPU 332 stores identification information of the failure images FI, for which the re-imaging is determined, in the memory 336.

Next, in a case where the re-imaging confirmation is completed, the recommended imaging parameter determination section 346 of the CPU 332 determines recommended imaging parameters for the imaging failure portions on the basis of the contents of the failure images FI. The recommended imaging parameter determination section 346 determines preferable recommended imaging parameters in accordance with the contents of the failure images FI. The recommended imaging parameter determination section 346 determines, as the recommended imaging parameters, imaging parameters (shutter speed, F number, exposure correction amount, ISO sensitivity, focus position, focal length, strobe light emission ON/OFF, strobe light emission amount, light ON/OFF, and the like) and the correction amounts of the imaging position, the imaging posture, and the like.

Description will be given of a case where the failure image FI includes an imaging failure portion that is determined to be “defocus” or “blurring”. In a case where the content is “defocus”, the recommended imaging parameter determination section 346 may determine that the content is simply “defocus”. In such a case, the recommended imaging parameter determination section 346 determines to not change the recommended imaging parameter. Further, the recommended imaging parameter determination section 346 determines a recommended imaging parameter corresponding to a case where the F number is increased (for example, from F5.6 to F8) in order to stop down the aperture. Therefore, the depth of field of the imaging apparatus 200 is increased.

In a case where the content is “defocus” and the recommended imaging parameter determination section 346 determines that the focus position does not match a desired object, the recommended imaging parameter determination section 346 determines a recommended imaging parameter corresponding to changing the focus position of the imaging apparatus 200.

In a case where the content is “blurring”, the recommended imaging parameter determination section 346 determines a recommended imaging parameter corresponding to increasing the shutter speed of the imaging apparatus 200, increasing of the ISO sensitivity, or decreasing the movement speed of the movable object 100 or stopping the movable object 100.

Description will be given of a case where the failure image FI includes an imaging failure portion that is determined to be “underexposure” or “overexposure”.

In a case where the content is “underexposure”, the recommended imaging parameter determination section 346 determines a recommended imaging parameter corresponding to setting of the exposure correction on a + side, causing the strobe to emit light, increasing the light emission amount of the strobe, or turning on the light.

In a case where the content is “overexposure”, the recommended imaging parameter determination section 346 determines a recommended imaging parameter corresponding to setting of the exposure correction on a − side, causing the strobe not to emit light, decreasing the light emission amount of the strobe, or turning off the light.

Description will be given of a case where the failure image FI includes an imaging failure portion that is determined to have an “insufficient imaging resolution”. In a case where the content is “insufficient imaging resolution”, the recommended imaging parameter determination section 346 determines a recommended imaging parameter corresponding to decreasing the imaging distance or increasing the focal length.

Description will be given of a case where the failure image FI includes an imaging failure portion for which it is determined that “it was determined that imaging is not performed on the front of the object at the imaging angle”. In a case where the content is “it was determined that imaging is not performed on the front of the object at the imaging angle”, the recommended imaging parameter determination section 346 determines a recommended imaging parameter corresponding to changing the imaging angle in an opposite direction or increasing the F number (for example, from F5.6 to F8) so as to stop down the aperture in order to increase the depth of field.

The recommended imaging parameter determination section 346 is able to determine, as a plurality of recommended imaging parameters, a parameter such as the failure image FI, a parameter such as the captured image ID adjacent to the failure image FI, or a plurality of parameters obtained by changing a range of a parameter determined in accordance with the failure image FI as described above. The imaging apparatus 200 of the movable object 100 acquires a plurality of re-captured images on the basis of the plurality of recommended imaging parameters. By using the information processing device 300, the best re-captured image may be selected from among the plurality of re-captured images.

Next, a description will be given of a step (Step S3) of specifying an imaging failure portion of a failure image for which it is determined that the criterion is not satisfied. In Step S3, the imaging failure portion specifying section 343 of the CPU 332 specifies an imaging failure portion by specifying the adjacent relationship between the plurality of captured images ID of the image group IG. Hereinafter, preferred aspects of Step S3 will be described.

One of the preferred aspects is a method of specifying the feature points on the basis of the association relationship of the feature points of the captured image ID. In such a method, feature points are extracted from the plurality of captured images ID, the association relationship of the feature points between the captured images ID is ascertained, and the plurality of captured images ID are combined, such that the adjacent relationship of the captured images ID is specified.

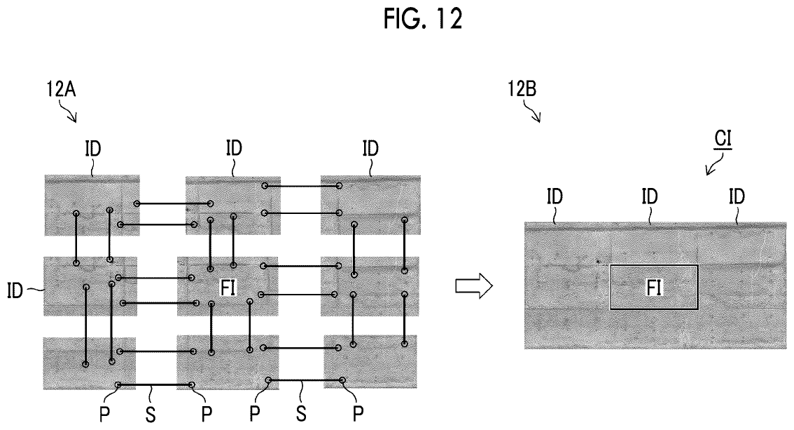

FIG. 12 is a diagram for describing processing of specifying the adjacent relationship of the captured images ID by using the above-mentioned method. The embodiment includes the association of the images shown in 12A of FIG. 12 and the combination of the images shown in 12B of FIG. 12. As shown in 12A, the imaging failure portion specifying section 343 extracts feature points P indicated by circles from the respective captured images ID in the association of the images. Next, the imaging failure portion specifying section 343 executes association between the feature points P extracted from the plurality of captured images ID by using a known method and extracts associated feature points P. Each straight line S indicates association of the feature points P. Next, the imaging failure portion specifying section 343 calculates a projective transformation matrix by associating the feature points P with each other. In 12A, the captured image ID includes the failure image FI.

Next, as shown in 12B, the imaging failure portion specifying section 343 combines the plurality of captured images ID (which include the failure images FI) on the basis of the association with the straight lines S to generate a composite image CI. In the composite image CI, the plurality of adjacent captured images ID overlap with each other on the basis of the association of the straight lines S. As shown in 12B, the composite image CI includes the failure image FI. By specifying the adjacent relationship of the image group IG, the failure image FI is specified. Thereby, an imaging failure portion in the object 500 is specified. The imaging failure portion display section 344 displays the failure image FI and the imaging failure portion on the display device 320 on the composite image CI shown in 12B.

According to another preferable aspect, there is a method of specifying the captured image ID on the basis of a positional relationship between the captured image ID and the object 500. In such a method, the imaging position and the imaging range of each captured image ID on the object 500 are estimated from the association between the imaging position and the direction of the captured image ID and the information about the structure and the position of the object 500. Thereby, the adjacent relationship of the captured images is specified. It should be noted that the imaging position and the direction of the captured image ID are an example of imaging conditions. The information about the structure and the position of the object 500 is an example of the information about the object 500. The information about the structure and the position of the object 500 can be acquired from three-dimensional model data, for example.

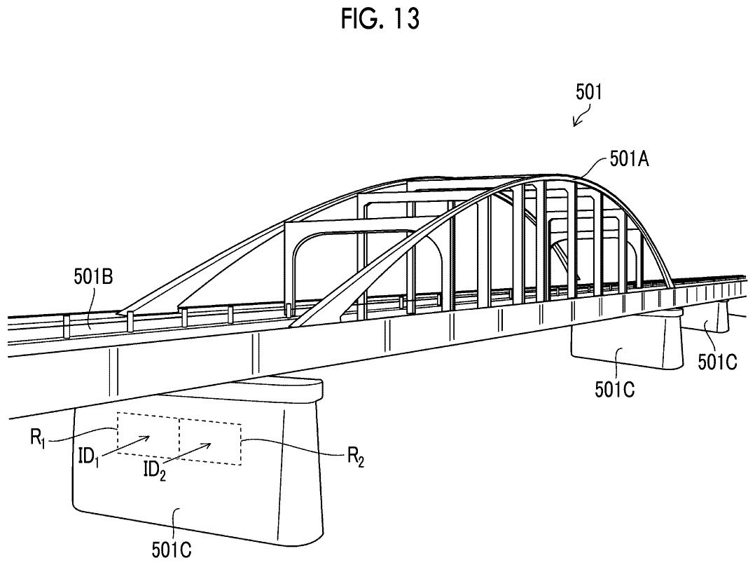

FIG. 13 is a diagram for describing processing of specifying the adjacent relationship of the captured images ID by using the above-mentioned method. In the embodiment, as shown in FIG. 13, three-dimensional model data 501, which includes information about the structure and the position of the object 500, and captured images ID₁ and ID₂ are applied. It should be noted that imaging ranges R₁ and R₂ indicate the imaging ranges of the captured images ID₁ and ID₂, respectively.

The three-dimensional model data 501 is an arch bridge, and includes an arch rib 501A, a deck slab 501B, and a bridge pier 501C. The three-dimensional model data 501 can be displayed as a point group, a polygon (mesh), a solid model, or the like. The three-dimensional model data 501 of FIG. 13 is a diagram in which a captured image (texture) obtained by capturing an image of the structure is texture-mapped on a multi-sided polygon. The three-dimensional model data 501 may be generated by a method such as SfM from the captured image ID, or may be three-dimensional model data created at the time of designing the object 500.

The imaging failure portion specifying section 343 calculates an imaging distance (distance to the object 500) from the association relationship between imaging positions and directions of the captured images ID₁ and ID₂ and the three-dimensional model data 501, and calculates the imaging range on the basis of the imaging distance and the focal length of the lens and information about the size of the imaging element. As shown in FIG. 13, the imaging failure portion specifying section 343 specifies the adjacent relationship between the captured images ID₁ and ID₂ by estimating the imaging ranges of the captured images ID₁ and ID₂ on the three-dimensional model data 501. It should be noted that the imaging distance may be directly acquired from the imaging apparatus 200 or the sensor section 154 of the movable object 100.

In a case where the imaging range (in the horizontal direction) and the imaging range (in the vertical direction) are defined as an imaging distance (D), a focal length (F) of the lens, and a sensor size (Sx, Sy), the imaging ranges can be calculated by Expression 4 and Expression 5.

Imaging range (in the horizontal direction)=D×Sx/F (Expression 4)

Imaging range (in the vertical direction)=D×Sy/F (Expression 5)

In a case where the processing ends, the imaging failure portion specifying section 343 stores the imaging failure portion in the memory 336 in association with the identification information of the failure image FI in the captured images ID.

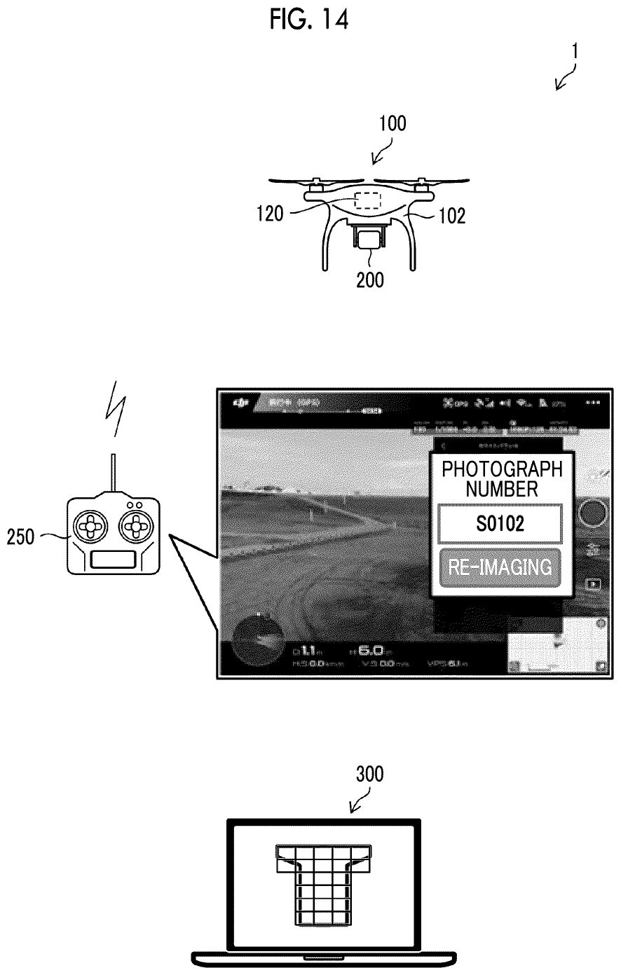

Next, the re-imaging using the imaging apparatus 200 of the movable object 100 will be described with reference to FIG. 14. In a case where the confirmation on the re-imaging confirmation screen shown in FIG. 11 is completed, the processing proceeds to a step of the re-imaging using the imaging apparatus 200 of the movable object 100.

As shown in FIG. 14, in a case where the information processing device 300 determines an imaging failure portion for which re-imaging is necessary, information thereof is transmitted to the movable object 100 via the controller 250. For example, a photograph number “S0102” is specified as the identification information, which is for specifying the imaging failure portion, and is transmitted to the movable object 100. As described above, in a case where the recommended imaging parameters are set, the identification information and the recommended imaging parameters are transmitted to the movable object 100.

Meanwhile, in a case where the control device 120 of the movable object 100 receives the identification information, which is for specifying the imaging failure portion, from the controller 250, the imaging instruction receiving section 132 receives an imaging instruction based on the imaging position information and the imaging posture information, as a re-imaging instruction for a so-called failure image FI.

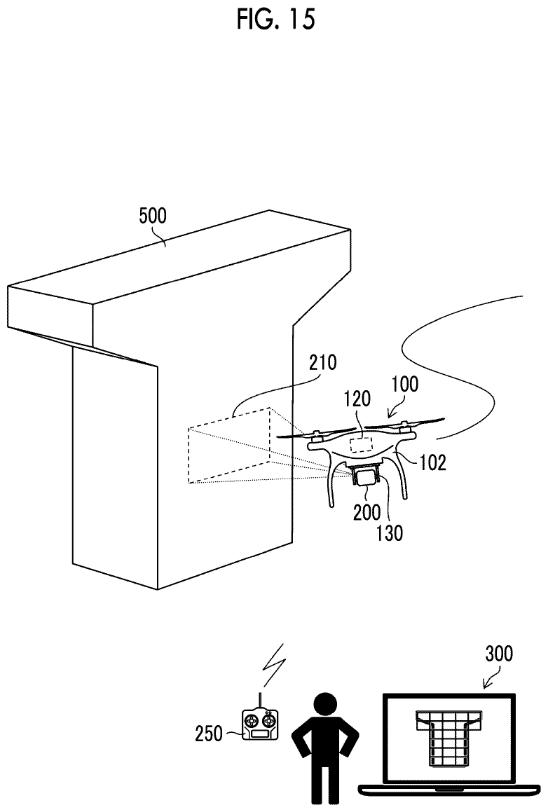

As shown in FIG. 15, in a case where the imaging instruction receiving section 132 of the movable object 100 receives the instruction, the movable object 100 automatically starts to capture an image of the imaging failure portion by using the imaging apparatus 200 under the control of the movement control section 124 and the imaging control section 126 of the control device 120.

The movement control section 124 and the imaging control section 126 acquire the imaging position information and the imaging posture information corresponding to the identification information, for which the instruction is received, from the memory 140. The imaging apparatus 200 of the movable object 100 performs re-imaging on the imaging failure portion on the basis of the imaging position information and the imaging posture information in a case of capturing the failure image FI. Therefore, the imaging work can be efficiently performed, and the work time can be reduced. Further, even in the object 500 having a few conspicuous features, the imaging apparatus 200 of the movable object 100 is able to easily perform re-imaging on a specific portion.

The case has been described in which the imaging position information and the imaging posture information are acquired from the memory 140 of the movable object 100. Meanwhile, in a case where the imaging position information and the imaging posture information are stored in the memory 336 of the information processing device 300, the imaging position information and the imaging posture information may be transmitted to the movable object 100 in addition to the identification information which is for specifying the imaging failure portion. The movement control section 124 and the imaging control section 126 acquire the imaging position information and the imaging posture information from the information processing device 300. The imaging apparatus 200 of the movable object 100 performs re-imaging on the imaging failure portion on the basis of the imaging position information and the imaging posture information in a case of capturing the failure image FI.

In a case where the imaging instruction receiving section 132 receives the recommended imaging parameter, the movement control section 124 and the imaging control section 126 acquire the imaging parameter and the correction amount, thereby controlling the imaging apparatus 200 and the movable object 100.

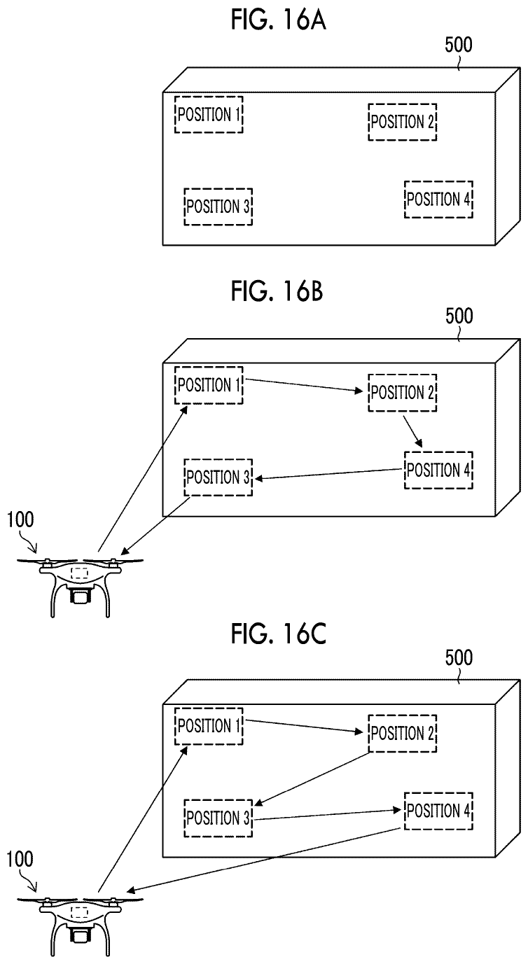

It should be noted that, in a case where the imaging instruction receiving section 132 receives a plurality of imaging instructions, the imaging route generation section 134 generates an imaging route for re-imaging. FIGS. 16A to 16C are diagrams for describing the generated imaging route. FIG. 16A shows a state where the imaging instruction receiving section 132 receives an imaging instruction for a total of four portions of a position 1, a position 2, a position 3, and a position 4. It should be noted that the position 1, the position 2, the position 3, and the position 4 indicate photograph numbers in a case of first imaging. Therefore, images of the imaging failure portion for which the imaging instruction is received are captured in the order of the position 1, the position 2, the position 3, and the position 4.

FIG. 16B shows a first imaging route generating method. The imaging route generation section 134 generates a route that minimizes a total moving distance of imaging at all portions (here, four portions) for which the imaging instruction is received. The movable object 100 is positioned at a home position. In a case where the imaging is started, the movable object 100 moves to the position 1 and captures an image of the imaging failure portion. Next, the movable object 100 moves to the position 2 and captures an image of the imaging failure portion, then moves to the position 4 and captures an image of the imaging failure portion, and finally moves to the position 3 and captures an image of the imaging failure portion. The movable object 100 returns to the home position. In the first imaging route generating method, an imaging route with a random imaging order and with the shortest total moving distance for imaging is generated.

FIG. 16C shows a second imaging route generating method. The imaging route generation section 134 generates a route having the shortest moving distance in a predetermined order (for example, in ascending order of photograph numbers for which imaging instructions are received). The movable object 100 is positioned at a home position. In a case where the imaging is started, the movable object 100 moves to the position 1 and captures an image of the imaging failure portion. Next, the movable object 100 moves to the position 2 and captures an image of the imaging failure portion, then moves to the position 3 and captures an image of the imaging failure portion, and finally moves to the position 4 and captures an image of the imaging failure portion. The movable object 100 returns to the home position. In the second imaging route generating method, movement is performed between imaging places by using the shortest distance.

Although the two generated imaging routes are exemplified, the imaging route is not limited thereto.

### <Other>

In the above-mentioned embodiment, the hardware structures of the processing units that execute various pieces of processing are various processors as follows. The various processors include: a central processing unit (CPU) as a general-purpose processor which functions as various processing units by executing software (programs); a programmable logic device (PLD) as a processor capable of changing a circuit configuration after manufacture, such as a field-programmable gate array (FPGA); a dedicated electrical circuit as a processor, which has a circuit configuration specifically designed to execute specific processing, such as an application-specific integrated circuit (ASIC); and the like.

One processing unit may be composed of one of the various processors or may be composed of two or more processors of the same type or different types (for example, a plurality of FPGAs or a combination of a CPU and an FPGA). Further, a plurality of processing units can be configured by one processor. As an example of configuring the plurality of processing units by one processor, first, there is a form in which one processor is configured of a combination of one or more CPUs and software, as represented by a computer such as a client or a server, and the one processor functions as the plurality of processing units. Second, as represented by a system-on-chip (SoC), there is a form in which a processor that realizes the functions of the whole system including a plurality of processing units with a single integrated circuit (IC) chip is used. As described above, the various processing units are configured by using one or more of the various processors as a hardware structure.

Further, the hardware structure of these various processors is, more specifically, an electric circuit (circuitry) in which circuit elements, such as semiconductor elements, are combined.

Each of the above-mentioned configurations and functions can be appropriately implemented by any hardware, software, or a combination of both. For example, it is also possible to apply the present invention to a program that causes a computer to execute the above-mentioned processing steps (processing procedures), a computer-readable storage medium (non-transitory storage medium) on which such a program is stored, or a computer on which such a program can be installed.

Although the examples of the present invention have been described above, the present invention is not limited to the above-mentioned embodiments, and various modifications can be made without departing from the scope of the present invention.

### EXPLANATION OF REFERENCES

1: movable object imaging system
100: movable object
102: movable object body
104: propulsion section
110: gimbal
120: control device
122: main control section
124: movement control section
126: imaging control section
128: imaging position information acquisition section
130: imaging posture information acquisition section
132: imaging instruction receiving section
134: imaging route generation section
140: memory
150: propeller driving motor
152: motor driver
154: sensor section
156: movable object communication section
200: imaging apparatus
202: subject
202A: subject surface
210: angle-of-view range
220: in-focus plane
220A: imaging range
222: subject surface vertical direction
224: direction of optical axis of imaging apparatus
226: front end of depth of field
228: rear end of depth of field
229: region
230: amount of shift in focal point on front side of in-focus plane
232: amount of shift in focal point on rear side of in-focus plane
250: controller
250A: controller operating section
250B: controller display section
250C: controller communication section
250D: control device
300: information processing device
310: operating section
320: display device
321: previous image button
322: subsequent image button
323: re-imaging button
324: end button
330: processing device control section
331: input output interface
332: CPU
333: ROM
334: RAM
335: display control section
336: memory
341: image group acquisition section
342: captured image determination section
343: imaging failure portion specifying section
344: imaging failure portion display section
345: re-imaging confirmation screen display section
346: recommended imaging parameter determination section
400: storage medium
500: object
501: three-dimensional model data
501A: arch rib
501B: deck slab
501C: bridge pier
CI: composite image
D_{f}: rear side depth of field
D_{N}: front side depth of field
DOF: depth of field
FI: failure image
ID: captured image
ID₁: captured image
ID₂: captured image
IG: image group
P: feature point
R₁: imaging range
R₂: imaging range
S: straight line
S1: step
S2: step
S3: step
S4: step
θ: imaging angle

What is claimed is:

1. A movable object comprising:
a movable object body;
an imaging apparatus that captures an image of an object;
a processor that acquires imaging position information and imaging posture information of the imaging apparatus in a case where the image of the object is captured by the imaging apparatus; and
a storage device that stores the imaging position information and the imaging posture information.

2. The movable object according to claim 1,
wherein the processor is configured to receive an imaging instruction based on the imaging position information and the imaging posture information.

3. The movable object according to claim 2,
wherein the imaging instruction includes a correction amount for at least one of the imaging position information or the imaging posture information.

4. The movable object according to claim 2,
wherein the imaging instruction includes an imaging parameter for the imaging apparatus.

5. The movable object according to claim 2,
wherein the processor is configured to generate an imaging route for the received imaging instruction.

6. The movable object according to claim 2,
wherein the processor is configured to control the imaging apparatus on the basis of the imaging instruction.

7. The movable object according to claim 1,
wherein the processor is configured to acquire
the imaging position information from a positioning sensor provided in the movable object body, and
the imaging posture information from an inertia measurement sensor provided in the movable object body.

8. The movable object according to claim 1,
wherein the movable object body is operated remotely or autonomously.

9. The movable object according to claim 1,
wherein the movable object body is an unmanned flying object or a mobile robot.

10. The movable object according to claim 1,
wherein the imaging apparatus acquires a two-dimensional color image.

11. The movable object according to claim 10,
wherein the imaging apparatus acquires three-dimensional data.

12. The movable object according to claim 1,
wherein the movable object is capable of communicating with an information processing device, and
the processor is configured to cause the movable object body to move to an imaging position based on the imaging position information and the imaging posture information stored in the storage device in a case where the processor receives an imaging instruction from the information processing device, and capturing is performed by the imaging apparatus.

13. The movable object according to claim 2,
wherein the processor is configured to receive from an outside of the movable object, the imaging instruction based on the imaging position information and the imaging posture information which have already been stored in the storage device.

14. The movable object according to claim 13,
wherein the imaging instruction includes identification information for specifying an captured image for which re-imaging is necessary, and
the processor is configured to acquire the imaging position information and the imaging posture information when the captured image was captured, from the storage device based on the identification information.

15. A movable object imaging system comprising:
a movable object that includes a movable object body and an imaging apparatus which captures an image of an object; and
an information processing device that is capable of communicating with the movable object,
wherein the information processing device includes a processor and a storage device,
the processor acquires imaging position information and imaging posture information of the imaging apparatus in a case where the image of the object is captured by the imaging apparatus, and
the storage device stores the imaging position information and the imaging posture information.

16. A movable object imaging method comprising:
a step of imaging an object with an imaging apparatus provided in a movable object;
a step of acquiring imaging position information and imaging posture information of the imaging apparatus in a case where the image of the object is captured by the imaging apparatus; and
a step of storing the imaging position information and the imaging posture information.

17. The movable object imaging method according to claim 16, further comprising:
a step of re-imaging the object on the basis of the imaging position information and the imaging posture information.
